(19) United States
(12) Patent Application Publication
(10) Pub. No.: US 2017/0297309 A1
(43) Pub. Date: Oct. 19, 2017

(54) RESIN FILM FOR BONDING TO GLASS PLATE, GLASS PLATE-CONTAINING LAMINATE, AND METHOD FOR PRODUCING RESIN FILM FOR BONDING TO GLASS PLATE

(71) Applicant: SEKISUI CHEMICAL CO., LTD., Osaka-city, Osaka (JP)

(72) Inventors: Shougo Yoshida, Kouka-city, Shiga (JP); Yuji Uchimura, Kouka-city, Shiga (JP); Akira Mizumori, Kouka-city, Shiga (JP); Hiroyuki Hirano, Kouka-city, Shiga (JP)

(21) Appl. No.: 15/515,585

(22) PCT Filed: Sep. 30, 2015
(86) PCT No.: PCT/JP2015/077865

§ 371 Date: Mar. 29, 2017

(30) Foreign Application Priority Data
Sep. 30, 2014 (JP) 2014-202620

(51) Int. Cl. B32B 17/10; B60R 21/34; B60R 21/02; B60J 1/00; B60R 21/00

(52) U.S. Cl. CPC B32B 17/10761; B60R 21/02; B60J 1/00; B60R 21/34; B32B 2605/00; B60R 2021/003

(57) ABSTRACT

There is provided a resin film for bonding glass plate members with which, when bonded to a glass plate, breakage of the resulting glass plate-containing laminate due to impact can be suppressed. The resin film for bonding glass plate members according to the present invention is a resin film bonded to a glass plate to be used and includes a thermoplastic resin and a plasticizer, and the tensile elongation at 25° C. under a stress load of 50 N is 120 mm or more in a tensile test in accordance with JIS K7113.

### TECHNICAL FIELD

The present invention relates to a resin film for bonding glass plate members which is bonded to a glass plate to be used and a method for producing a resin film for bonding glass plate members. Moreover, the present invention relates to a glass plate-containing laminate prepared with the resin film for bonding glass plate members.

### BACKGROUND ART

A glass plate-containing laminate in which a resin film is bonded to a glass plate has been known. Among glass plate-containing laminates, laminated glass has been widely used.

Since laminated glass generates only a small amount of scattering glass fragments even when subjected to external impact and broken, laminated glass is excellent in safety. As such, the laminated glass is widely used for automobiles, railway vehicles, aircraft, ships, buildings and the like. The laminated glass is produced by sandwiching a resin film between a pair of glass plates.

When laminated glass is used as a windshield of a vehicle such as an automobile, the head of an occupant of the vehicle sometimes collides with the windshield when the vehicle is involved in an accident or the like. When the head of an occupant collides with the windshield, the occupant penetrates through the windshield and sometimes jumps out to the outside of the vehicle. For the purpose of protecting the safety of an occupant, it is preferred that the occupant be prevented from penetrating through the windshield even if the head of the occupant collides with the windshield.

Moreover, the regal regulation on head protection for a pedestrian has been started in various countries, the head protection has been reinforced and the regulation on leg protection has been supplementarily added. At the time of a collision between a vehicle and a pedestrian, as a portion by which a fatal wound is inflicted on the pedestrian, the head is the most frequent portion. In Japan, a testing method for digitizing the injury to a head is prescribed. While assuming a collision of the head of a pedestrian with a windshield or the like, a dummy made in imitation of the adult human head (a headform impactor) is shot from a testing machine against an object and the impact received by the headform impactor is measured to be evaluated as the head injury criteria (HIC).

There have hitherto been many windshields with an HIC of greater than 1000. On the other hand, in recent years, it has been announced that there are windshields with an HIC of 1000 or less. Moreover, in recent years, a vehicle mounted with an air bag for pedestrian protection has been developed, and the HIC is remarkably lowered.

For example, the following Patent Document 1 discloses laminated glass with an HIC of 1000 or less. Moreover, the following Patent Document 2 discloses laminated glass with which, at the time of a collision with a collision object, the reaction force received by the collision object from the glass can be reduced.

### RELATED ART DOCUMENT

### Patent Document

Patent Document 1: WO 2005/018969 A1
Patent Document 2: JP 2005-112694 A

### SUMMARY OF THE INVENTION

### Problems to be Solved by the Invention

As described in Patent Document 1 or 2, a resin film in which, even if an occupant or a pedestrian collides with the laminated glass, the occupant or the pedestrian is hardly injured has been developed.

However, laminated glass prepared with a conventional resin film has yet to come to be sufficiently suppressed from being broken when an occupant or a pedestrian collides therewith.

An object of the present invention is to provide a resin film for bonding glass plate members with which, when bonded to a glass plate, breakage of the resulting glass plate-containing laminate due to impact can be suppressed and a method for producing a resin film for bonding glass plate members. Moreover, the present invention is also aimed at providing a glass plate-containing laminate prepared with the resin film for bonding glass plate members.

### Means for Solving the Problems

According to a broad aspect of the present invention, there is provided a resin film for bonding glass plate members which is bonded to a glass plate to be used and includes a thermoplastic resin and a plasticizer, a tensile elongation at 25° C. under a stress load of 50 N being 120 mm or more in a tensile test in accordance with JIS K7113.

In a specific aspect of the resin film for bonding glass plate members according to the present invention, the thermoplastic resin is a polyvinyl acetal resin.

In a specific aspect of the resin film for bonding glass plate members according to the present invention, the plasticizer includes triethylene glycol di-2-ethylhexanoate, and the content of triethylene glycol di-2-ethylhexanoate is 20 parts by weight or more and 40 parts by weight or less relative to 100 parts by weight of the thermoplastic resin.

In a specific aspect of the resin film for bonding glass plate members according to the present invention, the glass transition temperature is 10° C. or more and 40° C. or less.

According to a broad aspect of the present invention, there is provided a glass plate-containing laminate including a first glass plate and the resin film for bonding glass plate members described above, the resin film being bonded to the first glass plate.

In a specific aspect of the glass plate-containing laminate according to the present invention, the glass plate-containing laminate is provided with the first glass plate as a first laminated glass member, the resin film for bonding glass plate members and a second laminated glass member, the resin film is bonded to the first glass plate, the resin film is bonded to the second laminated glass member, and the resin film is arranged between the first glass plate and the second laminated glass member.

According to a broad aspect of the present invention, there is provided a method for producing the resin film for bonding glass plate members described above, the method including the steps of: obtaining a polyvinyl acetal resin as the thermoplastic resin; and molding a composition prepared by blending the polyvinyl acetal resin and the plasticizer to obtain a resin film for bonding glass plate members, the step of obtaining the polyvinyl acetal resin including a mixing step of mixing polyvinyl alcohol and an aldehyde and an aging step of aging a resin obtained by the mixing step, and the aging step including a heating step of heating the resin obtained by the mixing step to an aging temperature and a cooling step of cooling the resin immediately after the heating step.

### Effect of the Invention

Since the resin film for bonding glass plate members according to the present invention includes a thermoplastic resin and a plasticizer and the tensile elongation at 25° C. under a stress load of 50 N is 120 mm or more in a tensile test in accordance with JIS K7113, when the resin film is bonded to the glass plate, breakage of the resulting glass plate-containing laminate due to impact can be suppressed.

### BRIEF DESCRIPTION OF DRAWINGS

FIG. 1 is a partially cut-away sectional view showing a glass plate-containing laminate prepared with a resin film for bonding glass plate members in accordance with one embodiment of the present invention.

FIG. 2 is a partially cut-away sectional view showing a modified example of a glass plate-containing laminate prepared with a resin film for bonding glass plate members in accordance with one embodiment of the present invention.

FIG. 3 is a figure showing the shape of a test specimen used in the tensile test.

FIG. 4 is a figure for illustrating an HIC measuring apparatus.

FIG. 5 is a figure for illustrating an HIC measuring apparatus.

### MODE(S) FOR CARRYING OUT THE INVENTION

Hereinafter, the details of the present invention will be described.

The resin film for bonding glass plate members (in the present specification, sometimes abbreviated as “the resin film”) according to the present invention is bonded to a glass plate to be used.

The resin film according to the present invention includes a thermoplastic resin and a plasticizer. In the resin film according to the present invention, the tensile elongation at 25° C. under a stress load of 50 N is 120 mm or more in a tensile test in accordance with JIS K7113.

In the present invention, since the resin film is provided with the above-mentioned configuration, when the resin film is bonded to a glass plate, breakage of the resulting glass plate-containing laminate due to impact can be suppressed. For example, even if an object collides with a glass plate-containing laminate, the glass plate-containing laminate is hardly broken. In the present invention, the head injury criteria (HIC) can be effectively lowered. In the present invention, even if an occupant or a pedestrian collides with the laminated glass, the occupant or the pedestrian is hardly damaged.

From the viewpoint of further suppressing damage of the glass plate-containing laminate, the tensile elongation is preferably 125 mm or more and more preferably 135 mm or more. The tensile elongation is preferably 250 mm or less and more preferably 160 mm or less.

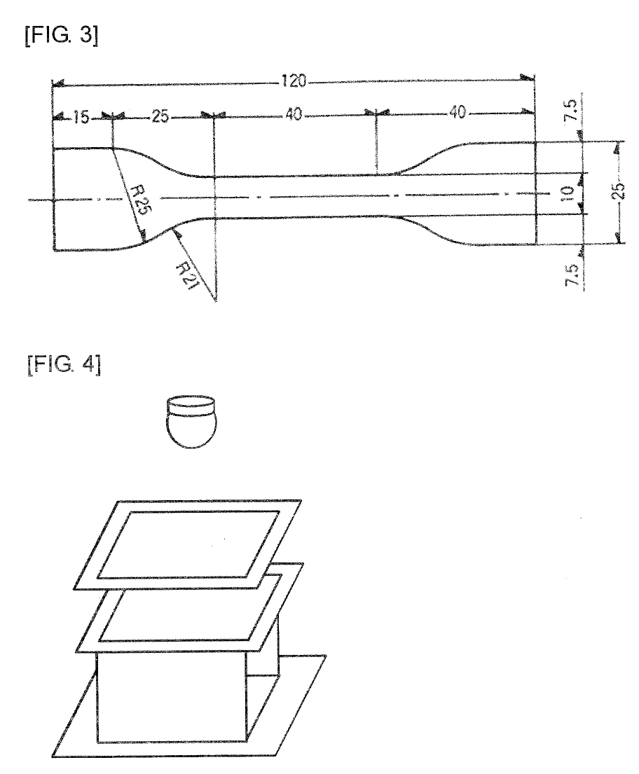

In this connection, the measurement of the tensile elongation is performed according to the following procedure. A resin composition for forming a resin film is extruded into a single-layered sheet-like shape to prepare a single-layered resin film with an average thickness of 0.76 mm. The resin film obtained is left to stand for 2 hours under the condition of 25° C. and a relative humidity of 30%. Afterward, in accordance with JIS K7113 “Tensile testing methods for plastics”, a test specimen is made in the shape of a dumbbell die (SDK-100) shown in FIG. 3, and a tensile test is performed using a TENSILON testing machine. The tensile test is performed under the condition of 25° C. and a relative humidity of 30%, the tensile speed is set to 200 mm/minute, and the tensile test is performed until the test specimen is broken. In the measurement results obtained, the elongation amount at the time of being applied with a load of 50 N is evaluated.

Hereinafter, respective materials which can be used for the resin film according to the present invention will be described in detail.

(Thermoplastic Resin)

A thermoplastic resin included in the resin film is not particularly limited. It is possible to use a conventionally known thermoplastic resin as the thermoplastic resin. One kind of the thermoplastic resin may be used alone, and two or more kinds thereof may be combinedly used.

Examples of the thermoplastic resin include a polyvinyl acetal resin, an ethylene-vinyl acetate copolymer resin, an ethylene-acrylic acid copolymer resin, a polyurethane resin, a polyvinyl alcohol resin, and the like. Thermoplastic resins other than these may be used.

It is preferred that the thermoplastic resin be a polyvinyl acetal resin. By using a polyvinyl acetal resin and a plasticizer together, the adhesive force of the resin film according to the present invention to a glass plate, a laminated glass member or another resin film is further heightened.

For example, the polyvinyl acetal resin can be produced by acetalizing polyvinyl alcohol with an aldehyde. It is preferred that the polyvinyl acetal resin be an acetalized product of polyvinyl alcohol. For example, the polyvinyl alcohol can be produced by saponifying polyvinyl acetate. The saponification degree of the polyvinyl alcohol generally lies within the range of 70 to 99.9% by mole.

The average polymerization degree of the polyvinyl alcohol is preferably 200 or more, more preferably 500 or more, preferably 3500 or less, more preferably 3000 or less, further preferably 2500 or less. When the average polymerization degree is the above lower limit or more, the penetration resistance of laminated glass is further enhanced. When the average polymerization degree is the above upper limit or less, formation of a resin film is facilitated.

In this connection, the average polymerization degree of the polyvinyl alcohol is determined by a method in accordance with JIS K6726 “Testing methods for polyvinyl alcohol”.

The number of carbon atoms of the acetal group contained in the polyvinyl acetal resin is not particularly limited. The aldehyde used at the time of producing the polyvinyl acetal resin is not particularly limited. It is preferred that the number of carbon atoms of the acetal group in the polyvinyl acetal resin be 3 or 4. When the number of carbon atoms of the acetal group in the polyvinyl acetal resin is 3 or more, the glass transition temperature of the resin film is sufficiently lowered.

The aldehyde is not particularly limited. In general, an aldehyde with 1 to 10 carbon atoms is suitably used as the above-mentioned aldehyde. Examples of the aldehyde with 1 to 10 carbon atoms include propionaldehyde, n-butyraldehyde, isobutyraldehyde, n-valeraldehyde, 2-ethylbutyraldehyde, n-hexylaldehyde, n-octylaldehyde, n-nonylaldehyde, n-decylaldehyde, formaldehyde, acetaldehyde, benzaldehyde, and the like. Of these, propionaldehyde, n-butyraldehyde, isobutyraldehyde, n-hexylaldehyde or n-valeraldehyde is preferred, propionaldehyde, n-butyraldehyde or isobutyraldehyde is more preferred, and n-butyraldehyde is further preferred. One kind of the aldehyde may be used alone, and two or more kinds thereof may be used in combination.

The content of the hydroxyl group (the amount of hydroxyl groups) of the polyvinyl acetal resin is preferably 15% by mole or more, more preferably 18% by mole or more, preferably 40% by mole or less, more preferably 35% by mole or less. When the content of the hydroxyl group is the above lower limit or more, the adhesive force of the resin film is further heightened. Moreover, when the content of the hydroxyl group is the above upper limit or less, the flexibility of the resin film is enhanced and the handling of the resin film is facilitated.

The content of the hydroxyl group of the polyvinyl acetal resin is a mole fraction, represented in percentage, obtained by dividing the amount of ethylene groups to which the hydroxyl group is bonded by the total amount of ethylene groups in the main chain. For example, the amount of ethylene groups to which the hydroxyl group is bonded can be measured in accordance with JIS K6728 “Testing methods for polyvinyl butyral”.

The acetylation degree (the amount of acetyl groups) of the polyvinyl acetal resin is preferably 0.1% by mole or more, more preferably 0.3% by mole or more, further preferably 0.5% by mole or more, preferably 30% by mole or less, more preferably 25% by mole or less, further preferably 20% by mole or less. When the acetylation degree is the above lower limit or more, the compatibility between the polyvinyl acetal resin and a plasticizer is heightened. When the acetylation degree is the above upper limit or less, with regard to the resin film and glass plate-containing laminate, the moisture resistance thereof is enhanced.

The acetylation degree is a mole fraction, represented in percentage, obtained by dividing the amount of ethylene groups to which the acetyl group is bonded by the total amount of ethylene groups in the main chain. For example, the amount of ethylene groups to which the acetyl group is bonded can be measured in accordance with JIS K6728 “Testing methods for polyvinyl butyral”.

The acetalization degree of the polyvinyl acetal resin (the butyralization degree in the case of a polyvinyl butyral resin) is preferably 60% by mole or more, more preferably 63% by mole or more, preferably 85% by mole or less, more preferably 75% by mole or less and further preferably 70% by mole or less. When the acetalization degree is the above lower limit or more, the compatibility between the polyvinyl acetal resin and a plasticizer is heightened. When the acetalization degree is the above upper limit or less, the reaction time required for producing the polyvinyl acetal resin is shortened.

The acetalization degree is a mole fraction, represented in percentage, obtained by dividing a value obtained by subtracting the amount of ethylene groups to which the hydroxyl group is bonded and the amount of ethylene groups to which the acetyl group is bonded from the total amount of ethylene groups in the main chain by the total amount of ethylene groups in the main chain.

In this connection, it is preferred that the content of the hydroxyl group (the amount of hydroxyl groups), the acetalization degree (the butyralization degree) and the acetylation degree be calculated from the results measured by a method in accordance with JIS K6728 “Testing methods for polyvinyl butyral”. In this context, a method in accordance with ASTM D1396-92 may be used. When the polyvinyl acetal resin is a polyvinyl butyral resin, it is preferred that the content of the hydroxyl group (the amount of hydroxyl groups), the acetalization degree (the butyralization degree) and the acetylation degree be calculated from the results measured by a method in accordance with JIS K6728 “Testing methods for polyvinyl butyral”.

It is preferred that the polyvinyl acetal resin be obtained through the step including a mixing step of mixing the polyvinyl alcohol and the aldehyde and an aging step of aging a resin obtained by the mixing step.

It is preferred that the step of obtaining the polyvinyl acetal resin include a mixing step of mixing polyvinyl alcohol and an aldehyde and an aging step of aging a resin obtained by the mixing step.

Although the aging step is not particularly limited, examples thereof include the step having an addition step of adding a kind of acid to a resin obtained by the mixing step, a heating step of heating the contents to an aging temperature, a holding step of holding the temperature of the contents at the aging temperature and a cooling step of cooling the contents (some of these steps may be omitted) in this order, and the like.

From the viewpoint of improving the tensile elongation, for example, at the time of synthesizing a polyvinyl acetal resin, it is preferred that the aging time in the holding step be adjusted to reduce the existence ratio of adjacent hydroxyl groups. Specifically, the aging time in the holding step can be shortened to reduce the existence ratio of adjacent hydroxyl groups. Alternatively, by omitting the holding step, the resin can be cooled immediately after the heating step to reduce the existence ratio of adjacent hydroxyl groups. When the resin is cooled immediately after the heating step, without holding the temperature of the contents after heating at a temperature of the aging temperature ±5° C. for 90 minutes or more, cooling is started. When the resin is cooled immediately after the heating step, it is preferred that cooling be started without holding the temperature of the contents after heating at a temperature of the aging temperature ±5° C. for 60 minutes or more, and it is more preferred that cooling be started without holding the temperature of the contents after heating at a temperature of the aging temperature ±5° C. for 15 minutes or more.

Separately, the aging temperature can be adjusted to reduce the existence ratio of adjacent hydroxyl groups. It is preferred that the aging temperature be 50° C. or more, and it is preferred that the aging temperature be 60° C. or less. It is preferred that a kind of acid added to the polyvinyl acetal resin be hydrochloric acid or nitric acid.

(Plasticizer)

From the viewpoint of further heightening the adhesive force of a resin film, the resin film includes a plasticizer. When the thermoplastic resin included in a resin film is a polyvinyl acetal resin, it is especially preferred that the resin film include a plasticizer.

The plasticizer is not particularly limited. As the plasticizer, a conventionally known plasticizer can be used. One kind of the plasticizer may be used alone, and two or more kinds thereof may be used in combination.

Examples of the plasticizer include organic ester plasticizers such as a monobasic organic acid ester and a polybasic organic acid ester, organic phosphate plasticizers such as an organic phosphate plasticizer and an organic phosphite plasticizer, and the like. Of these, organic ester plasticizers are preferred. It is preferred that the plasticizer be a liquid plasticizer.

The monobasic organic acid ester is not particularly limited and examples thereof include a glycol ester obtained by the reaction of a glycol with a monobasic organic acid, an ester of triethylene glycol or tripropylene glycol with a monobasic organic acid, and the like. Examples of the glycol include triethylene glycol, tetraethylene glycol, tripropylene glycol, and the like. Examples of the monobasic organic acid include butyric acid, isobutyric acid, caproic acid, 2-ethylbutyric acid, hepthylic acid, n-octylic acid, 2-ethylhexanoic acid, n-nonylic acid, decanoic acid, and the like.

The polybasic organic acid ester is not particularly limited and examples thereof include an ester compound of a polybasic organic acid and an alcohol having a linear or branched structure of 4 to 8 carbon atoms. Examples of the polybasic organic acid include adipic acid, sebacic acid, azelaic acid and the like.

The organic ester plasticizer is not particularly limited and examples thereof include triethylene glycol di-2-ethylbutyrate, triethylene glycol di-2-ethylhexanoate, triethylene glycol dicaprylate, triethylene glycol di-n-octanoate, triethylene glycol di-n-heptanoate, tetraethylene glycol di-n-heptanoate, dibutyl sebacate, dioctyl azelate, dibutyl carbitol adipate, ethylene glycol di-2-ethylbutyrate, 1,3-propylene glycol di-2-ethylbutyrate, 1,4-butylene glycol di-2-ethylbutyrate, diethylene glycol di-2-ethylbutyrate, diethylene glycol di-2-ethylhexanoate, dipropylene glycol di-2-ethylbutyrate, triethylene glycol di-2-ethylpentanoate, tetraethylene glycol di-2-ethylbutyrate, diethylene glycol dicapryate, dihexyl adipate, dioctyl adipate, hexyl cyclohexyl adipate, a mixture of heptyl adipate and nonyl adipate, diisononyl adipate, diisodecyl adipate, heptyl nonyl adipate, dibutyl sebacate, oil-modified sebacic alkyds, a mixture of a phosphoric acid ester and an adipic acid ester, and the like. Organic ester plasticizers other than these may be used.

The organic phosphate plasticizer is not particularly limited and examples thereof include tributoxyethyl phosphate, isodecyl phenyl phosphate, triisopropyl phosphate and the like.

It is preferred that the plasticizer be a diester plasticizer represented by the following formula (1).

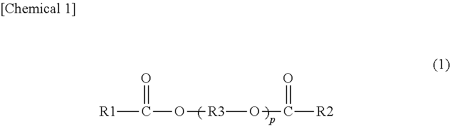

In the foregoing formula (1), R1 and R2 each represent an organic group with 5 to 10 carbon atoms, R3 represents an ethylene group, an isopropylene group or an n-propylene group, and p represents an integer of 3 to 10. It is preferred that R1 and R2 in the foregoing formula (1) each be an organic group with 6 to 10 carbon atoms.

It is preferred that the plasticizer include triethylene glycol di-2-ethylhexanoate (3GO) or triethylene glycol di-2-ethylbutyrate, and it is more preferred that the plasticizer include triethylene glycol di-2-ethylhexanoate.

The content of the plasticizer is not particularly limited. Relative to 100 parts by weight of the thermoplastic resin, the content of the plasticizer is preferably 25 parts by weight or more, more preferably 30 parts by weight or more, preferably 60 parts by weight or less, more preferably 50 parts by weight or less, further preferably 45 parts by weight or less and still further preferably 40 parts by weight or less. When the content of the plasticizer is not less than the above lower limit, the penetration resistance of laminated glass is further enhanced. When the content of the plasticizer is not more than the above upper limit, the transparency of the resin film is further enhanced.

From the viewpoint of further suppressing damage of the glass plate-containing laminate, it is preferred that the plasticizer include triethylene glycol di-2-ethylhexanoate, and relative to 100 parts by weight of the thermoplastic resin, the content of triethylene glycol di-2-ethylhexanoate be 20 parts by weight or more and 40 parts by weight or less.

(Other Ingredients)

The resin film may include additives such as an ultraviolet ray screening agent, an oxidation inhibitor, a light stabilizer, a flame retardant, an antistatic agent, a pigment, a dye, a moisture-resistance improving agent, an adhesive force regulating agent, a fluorescent brightening agent and an infrared ray absorber, as necessary. One kind of these additives may be used alone, and two or more kinds thereof may be combinedly used.

(Other Details of Resin Film)

From the viewpoints of further effectively lowering the HIC and effectively enhancing the penetration resistance of laminated glass, it is preferred that the glass transition temperature of the resin film is preferably 10° C. or more, more preferably 15° C. or more, further preferably 20° C. or more, preferably 45° C. or less, more preferably 40° C. or less and further preferably 35° C. or less.

The thickness of the resin film according to the present invention is not particularly limited. From the viewpoint of the practical aspect and the viewpoint of sufficiently heightening the heat shielding properties, the thickness of the resin film is preferably 0.1 mm or more, more preferably 0.25 mm or more, preferably 3 mm or less and more preferably 1.5 mm or less. When the thickness of the resin film is not less than the above lower limit, the penetration resistance of laminated glass is enhanced. When the thickness of the resin film is not more than the above upper limit, the transparency of the resin film is further improved.

The production method of the resin film is not particularly limited. As the production method of the resin film, a conventionally known method can be used. Examples thereof include a production method of kneading ingredients to be blended and forming the kneaded product into a resin film, and the like. A production method of extrusion-molding is preferred because the method is suitable for continuous production.

Above all, it is preferred that the production method of the resin film be provided with the step of obtaining a polyvinyl acetal resin as the thermoplastic resin and the step of molding a composition prepared by blending the polyvinyl acetal resin and the plasticizer to obtain a resin film for bonding glass plate members. Furthermore, it is preferred that the step of obtaining the polyvinyl acetal resin include a mixing step of mixing polyvinyl alcohol and an aldehyde and an aging step of aging a resin obtained by the mixing step. Moreover, it is preferred that the aging step include a heating step of heating the resin obtained by the mixing step to an aging temperature and a cooling step of cooling the resin immediately after the heating step.

The method for kneading is not particularly limited. Examples of this method include a method using an extruder, a plastograph, a kneader, a banbury mixer, a calender roll, or the like. Of these, a method using an extruder is preferred and a method using a twin screw extruder is more preferred because the methods are suitable for continuous production.

The resin film according to the present invention may be used alone for a sheet of laminated glass and may be used together with another resin film for a sheet of laminated glass. The resin film according to the present invention in a state of being layered on another resin film can be used as a multilayer resin film.

(Glass Plate-Containing Laminate)

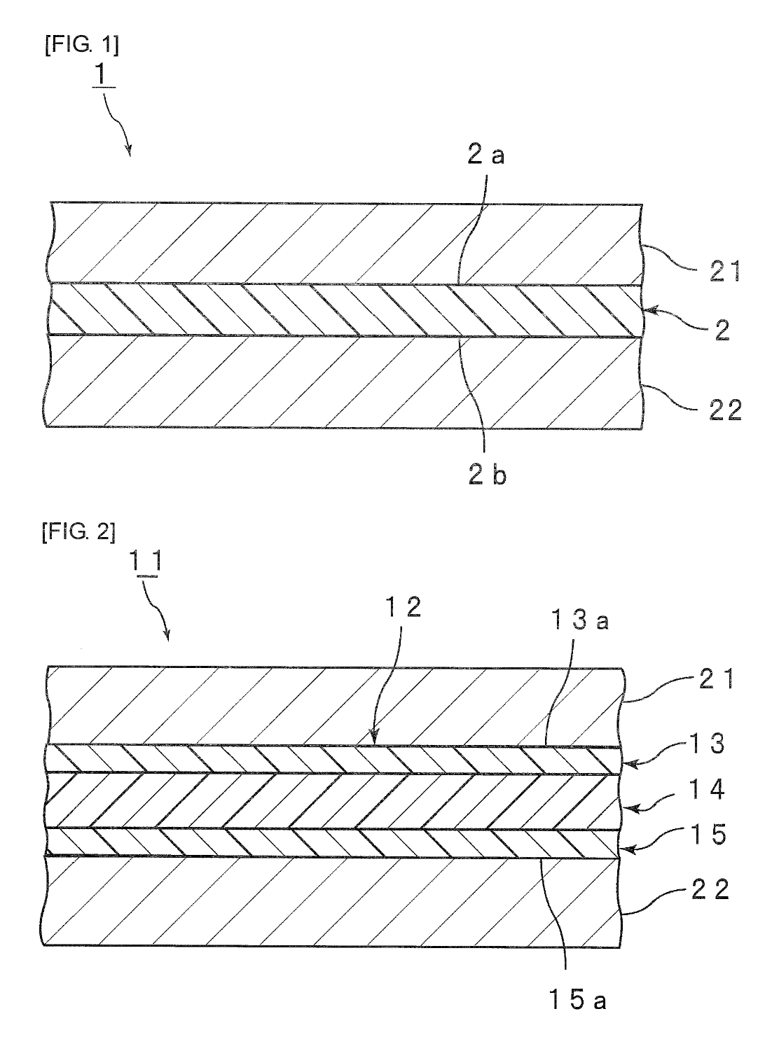

FIG. 1 is a sectional view showing an example of a glass plate-containing laminate prepared with a resin film bonded to a glass plate in accordance with one embodiment of the present invention.

A glass plate-containing laminate 1 shown in FIG. 1 is provided with a resin film 2, a first laminated glass member 21 (a first glass plate) and a second laminated glass member 22 (may be a second glass plate). The resin film 2 is a single-layered resin film. The resin film 2 is used for obtaining a glass plate-containing laminate. The resin film 2 is a resin film bonded to a glass plate to be used. The glass plate-containing laminate 1 is a sheet of laminated glass.

The resin film 2 is arranged between the first laminated glass member 21 and the second laminated glass member 22 to be sandwiched therebetween. The first laminated glass member 21 is layered on a first surface 2a (one surface) of the resin film 2. The second laminated glass member 22 is layered on a second surface 2b (the other surface) opposite to the first surface 2a of the resin film 2.

FIG. 2 is a sectional view showing a modified example of a glass plate-containing laminate prepared with a resin film bonded to a glass plate in accordance with one embodiment of the present invention.

A glass plate-containing laminate 11 shown in FIG. 2 is provided with a resin film 12, a first laminated glass member 21 (a first glass plate) and a second laminated glass member 22. The resin film 12 is a multi-layered resin film. The resin film 12 is used for obtaining a glass plate-containing laminate. The resin film 12 is a resin film bonded to a glass plate to be used. The glass plate-containing laminate 11 is a sheet of laminated glass.

The resin film 12 has a structure in which three resin films of a first layer 13 (a resin film), a second layer 14 (a resin film) and a third layer 15 (a resin film) are layered in this order. In the present embodiment, the second layer 14 is a sound insulating layer. As the second layer 14, the resin film in accordance with one embodiment of the present invention is used. The second layer 14 is bonded to the first and second laminated glass members 21, 22 through the first and third layers 13, 15 respectively. The first and third layers 13, 15 are protective layers. The first and third layers 13, 15 may also be resin films in accordance with the embodiment of the present invention.

The resin film 12 is arranged between the first laminated glass member 21 and the second laminated glass member 22 to be sandwiched therebetween. The second layer 14 (a resin film) is interposed between the first and third layers 13, 15 to be arranged between the first laminated glass member 21 and the second laminated glass member 22. The first laminated glass member 21 is layered on an outer surface 13a of the first layer 13. The second laminated glass member 22 is layered on an outer surface 15a of the second layer 15.

As described above, the glass plate-containing laminate according to the present invention needs only to be provided with a first glass plate and a resin film according to the present invention. It is preferred that the resin film be arranged between the first laminated glass member (a first glass plate) and the second laminated glass member. The glass plate-containing laminate may be provided with only a resin film bonded to a glass plate according to the present invention as the resin film, and may be provided with a resin film bonded to a glass plate according to the present invention and another resin film as the resin film. The glass plate-containing laminate includes at least the resin film bonded to a glass plate according to the present invention.

Examples of the laminated glass member include a glass plate, a PET (polyethylene terephthalate) film, and the like. As the laminated glass, laminated glass in which a resin film is sandwiched between a glass plate and a PET film or the like, as well as laminated glass in which a resin film is sandwiched between two glass plates, is included. Laminated glass is a laminate provided with a glass plate, and it is preferred that at least one glass plate be used. It is preferred that the second laminated glass member be a glass plate or a PET film.

Examples of the glass plate include a sheet of inorganic glass and a sheet of organic glass. Examples of the inorganic glass include float plate glass, heat ray-absorbing plate glass, heat ray-reflecting plate glass, polished plate glass, figured glass, wired plate glass and the like. The organic glass is synthetic resin glass substituted for inorganic glass. Examples of the organic glass include a polycarbonate plate, a poly(meth)acrylic resin plate, and the like. Examples of the poly(meth)acrylic resin plate include a polymethyl (meth)acrylate plate, and the like.

The thickness of the laminated glass member is preferably 1 mm or more, preferably 5 mm or less and more preferably 3 mm or less. Moreover, the thickness of the glass plate is preferably 1 mm or more, preferably 5 mm or less and more preferably 3 mm or less. When the laminated glass member is a PET film, the thickness of the PET film is preferably 0.03 mm or more and preferably 0.5 mm or less.

The production method of the glass plate-containing laminate is not particularly limited. The resin film can be bonded to the first glass plate to obtain a glass plate-containing laminate. Furthermore, for example, a resin film is sandwiched between a first laminated glass member and a second laminated glass member, and the air remaining between the first laminated glass member and the resin film and between the second laminated glass member and the resin film is removed by passing the members through a pressing roll or by putting the members into a rubber bag to be sucked under reduced pressure. Afterward, the members are preliminarily bonded together at about 70 to 110° C. to obtain a laminate. Next, by putting the laminate into an autoclave or by pressing the laminate, the members are press-bonded together at about 120 to 150° C. and under a pressure of 1 to 1.5 MPa. In this way, laminated glass, which is a glass plate-containing laminate, can be obtained.

Each of the resin film and the glass plate-containing laminate can be used for automobiles, railway vehicles, aircraft, ships, buildings and the like. Each of the resin film and the glass plate-containing laminate can also be used for applications other than these applications. It is preferred that the resin film and the glass plate-containing laminate be a resin film and a glass plate-containing laminate for vehicles or for building respectively, and it is more preferred that the resin film and the glass plate-containing laminate be a resin film and a glass plate-containing laminate for vehicles respectively. Each of the resin film and the glass plate-containing laminate can be used for a windshield, side glass, rear glass or roof glass of an automobile, and the like.

Hereinafter, the present invention will be described in more detail with reference to examples below. The present invention is not limited only to these examples.

With regard to the polyvinyl butyral (PVB) resin used in the following examples and comparative examples, the butyralization degree (the acetalization degree), the acetylation degree and the content of the hydroxyl group were measured by a method in accordance with JIS K6728 “Testing methods for polyvinyl butyral”. In this connection, even in the cases of being measured according to ASTM D1396-92, numerical values similar to those obtained by a method in accordance with JIS K6728 “Testing methods for polyvinyl butyral” were exhibited.

### Synthesis Example 1

In a reactor equipped with a stirring apparatus, 3400 ml of ion-exchanged water and 300 g of polyvinyl alcohol (the average polymerization degree of 1700, the saponification degree of 99% by mole) were placed, and the contents were heated and dissolved with stirring to obtain a solution. Next, to this solution, 60% by weight nitric acid as a catalyst was added so that the nitric acid concentration becomes 0.45% by weight, the temperature was adjusted to 15° C., and then, 30 g of n-butyraldehyde was added with stirring. Afterward, 137 g of n-butyraldehyde was added, whereupon a polyvinyl butyral resin in a white particulate form precipitated. At the end of 15 minutes after the precipitation, 60% by weight nitric acid was added so that the nitric acid concentration becomes 1.6% by weight, the contents were heated to 60° C., the solution was cooled at the point of time when the temperature reached 60° C. and neutralized, after which the polyvinyl butyral resin was washed with water and dried to obtain a polyvinyl butyral resin (1).

### Synthesis Example 2

In a reactor equipped with a stirring apparatus, 3400 ml of ion-exchanged water and 300 g of polyvinyl alcohol (the average polymerization degree of 1700, the saponification degree of 99% by mole) were placed, and the contents were heated and dissolved with stirring to obtain a solution. Next, to this solution, 60% by weight nitric acid as a catalyst was added so that the nitric acid concentration becomes 0.45% by weight, the temperature was adjusted to 15° C., and then, 30 g of n-butyraldehyde was added with stirring. Afterward, 154 g of n-butyraldehyde was added, whereupon a polyvinyl butyral resin in a white particulate form precipitated. At the end of 15 minutes after the precipitation, 60% by weight nitric acid was added so that the nitric acid concentration becomes 1.6% by weight, the contents were heated to 55° C., the solution was cooled at the point of time when the temperature reached 55° C. and neutralized, after which the polyvinyl butyral resin was washed with water and dried to obtain a polyvinyl butyral resin (2).

### Synthesis Example 3

In a reactor equipped with a stirring apparatus, 3400 ml of ion-exchanged water and 300 g of polyvinyl alcohol (the average polymerization degree of 1700, the saponification degree of 99% by mole) were placed, and the contents were heated and dissolved with stirring to obtain a solution. Next, to this solution, 60% by weight nitric acid as a catalyst was added so that the nitric acid concentration becomes 0.45% by weight, the temperature was adjusted to 15° C., and then, 30 g of n-butyraldehyde was added with stirring. Afterward, 137 g of n-butyraldehyde was added, whereupon a polyvinyl butyral resin in a white particulate form precipitated. At the end of 15 minutes after the precipitation, 60% by weight nitric acid was added so that the nitric acid concentration becomes 1.6% by weight, the contents were heated to 55° C., the solution was cooled at the point of time when the temperature reached 55° C. and neutralized, after which the polyvinyl butyral resin was washed with water and dried to obtain a polyvinyl butyral resin (3).

### Synthesis Example 4

In a reactor equipped with a stirring apparatus, 3400 ml of ion-exchanged water and 300 g of polyvinyl alcohol (the average polymerization degree of 1700, the saponification degree of 99% by mole) were placed, and the contents were heated and dissolved with stirring to obtain a solution. Next, to this solution, 60% by weight nitric acid as a catalyst was added so that the nitric acid concentration becomes 0.45% by weight, the temperature was adjusted to 15° C., and then, 30 g of n-butyraldehyde was added with stirring. Afterward, 137 g of n-butyraldehyde was added, whereupon a polyvinyl butyral resin in a white particulate form precipitated. At the end of 15 minutes after the precipitation, 60% by weight nitric acid was added so that the nitric acid concentration becomes 1.6% by weight, the contents were heated to 50° C., the solution was cooled at the point of time when the temperature reached 50° C. and neutralized, after which the polyvinyl butyral resin was washed with water and dried to obtain a polyvinyl butyral resin (4).

### Synthesis Example 5

In a reactor equipped with a stirring apparatus, 2700 ml of ion-exchanged water and 300 g of polyvinyl alcohol (the average polymerization degree of 1700, the saponification degree of 99% by mole) were placed, and the contents were heated and dissolved with stirring to obtain a solution. Next, to this solution, 60% by weight nitric acid as a catalyst was added so that the nitric acid concentration becomes 0.4% by weight, the temperature was adjusted to 15° C., and then, 23 g of n-butyraldehyde was added with stirring. Afterward, 140 g of n-butyraldehyde was added, whereupon a polyvinyl butyral resin in a white particulate form precipitated. At the end of 15 minutes after the precipitation, 60% by weight nitric acid was added so that the nitric acid concentration becomes 1.6% by weight, and the contents were heated to 65° C. and aged for 2 hours at 65° C. Then, the solution was cooled and neutralized, after which the polyvinyl butyral resin was washed with water and dried to obtain a polyvinyl butyral resin (A).

### Synthesis Example 6

In a reactor equipped with a stirring apparatus, 2700 ml of ion-exchanged water and 300 g of polyvinyl alcohol (the average polymerization degree of 2300, the saponification degree of 87.5% by mole) were placed, and the contents were heated and dissolved with stirring to obtain a solution. Next, to this solution, 35% by weight hydrochloric acid as a catalyst was added so that the hydrochloric acid concentration becomes 0.6% by weight, the temperature was adjusted to 15° C., and then, 14.2 g of n-butyraldehyde was added with stirring. Afterward, 170 g of n-butyraldehyde was added, whereupon a polyvinyl butyral resin in a white particulate form precipitated. At the end of 15 minutes after the precipitation, 35% by weight hydrochloric acid was added so that the hydrochloric acid concentration becomes 3.9% by weight, and the contents were heated to 45° C. and aged for 3 hours at 45° C. Then, the solution was cooled and neutralized, after which the polyvinyl butyral resin was washed with water and dried to obtain a polyvinyl butyral resin (B).

### Example 1

Preparation of Resin Film:

To 100 parts by weight of a polyvinyl butyral resin (1), 40 parts by weight of triethylene glycol di-2-ethylhexanoate (3GO), which is a plasticizer, was added and thoroughly kneaded with a mixing roll to obtain a composition.

The composition obtained was extruded by an extruder to obtain a single-layered resin film (760 μm in average thickness).

Preparation of Laminated Glass:

The resin film obtained was cut into a size of 110 cm in longitudinal length×110 cm in transversal length. Next, the resin film was sandwiched between two sheets of clear glass (110 cm in longitudinal length×110 cm in transversal length×2.5 mm in thickness), held in place for 30 minutes at 90° C. and pressed under vacuum with a vacuum laminator to obtain a sheet of laminated glass.

### Examples 2 to 4 and Comparative Examples 1, 2

A resin film and a sheet of laminated glass were obtained in the same manner as that in Example 1 except that the kind of ingredients to be blended for the composition and the blending amount thereof were set to those listed in the following Table 1.

(Evaluation)

(1) Glass Transition Temperature

Resin films with an average thickness 0.76 mm obtained in examples and comparative examples were left to stand for 2 hours under the condition of 25° C. and a relative humidity of 30%. Afterward, the viscoelasticity thereof was measured by means of the ARES-G2 available from TA Instruments Japan Inc. As a jig, a parallel plate with a diameter of 8 mm was used. The measurement was performed under the condition in which the temperature is decreased from 100° C. to −10° C. at a temperature decreasing rate of 3° C./minute and under the condition of a frequency of 1 Hz and a strain of 1%. In the measurement results obtained, the peak temperature of the loss tangent was defined as the glass transition temperature Tg (° C.).

(2) Tensile Elongation

Resin films with an average thickness of 0.76 mm obtained in examples and comparative examples were left to stand for 2 hours under the condition of 25° C. and a relative humidity of 30%. Afterward, in accordance with JIS K7113 “Tensile testing methods for plastics”, a test specimen was made in the shape of a dumbbell die (SDK-100) shown in FIG. 3, and a tensile test was performed using a TENSILON testing machine. The tensile test was performed under the condition of 25° C. and a relative humidity of 30%, the tensile speed was set to 200 mm/minute, and the tensile test was performed until the test specimen is broken. In the measurement results obtained, the elongation amount at the time of being applied with a load of 50 N was evaluated.

(3) Breaking Energy

A resin film with an average thickness of 0.76 mm was left to stand for 2 hours under the condition of 25° C. and a relative humidity of 30%. Afterward, in accordance with JIS K7113 “Tensile testing methods for plastics”, a test specimen was made in the shape of a dumbbell die (SDK-100) shown in FIG. 3, and a tensile test was performed using a TENSILON testing machine to prepare a stress-strain curve. The tensile test was performed under the condition of 25° C. and a relative humidity of 30%, the tensile speed was set to 200 mm/minute, and the tensile test was performed until the test specimen is broken. From the area of a region surrounded by the stress-strain curve obtained and the x-axis, the breaking energy was determined.

(4) HIC

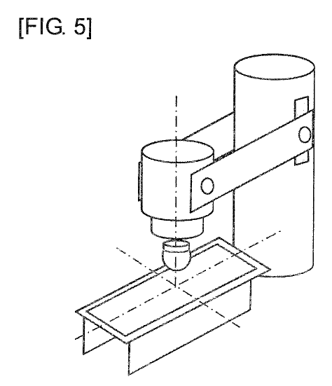

A sheet of laminated glass was cut into a size of 50 cm in longitudinal length by 110 cm in transversal length to prepare a Sample 2. Using an HIC measuring apparatus having a structure shown in FIG. 4 and FIG. 5, the sample was measured for the HIC. As shown in the figure, the HIC apparatus has such a structure that the outer peripheral part of a sheet of laminated glass is fixed thereby. With regard to the headform impactor, the metal-made core thereof is attached with a resin-made head skin with a hemispherical shape. A triaxial direction acceleration sensor is installed therein. The headform impactor is a dummy which is made in imitation of the human head and used in “a pedestrian protection performance test” for the certification test for automobiles such as NCAP. By means of the apparatus shown in the figure, the headform impactor was shot at a speed of 35 km/h to the center of the sheet of laminated glass and brought into collision with the sheet of laminated glass.

The HIC is calculated from the following equation. In the equation, a represents the resultant acceleration of an impact head, and t2−t1 is defined as a time interval of 15 ms. With regard to the specific testing method, the test was performed according to the contents described in “Safety standards for road trucking vehicles: Public notice of details, Appendix 99, Technical standards for pedestrian head protection” published by Ministry of Land, Infrastructure, Transport and Tourism. The HIC was judged according to the following criteria.

$$HIC = {( \frac{1}{t 2 - t 1} {\int }_{t 1}^{t 2} \frac{a}{9.8} dt )}^{2.5} ( t 2 - t 1 ) \qquad [ Mathematical 1 ]$$

Criteria for Judgment in [HIC]

Two circles: The HIC is 200 or less.

One circle: The HIC is greater than 200 and 350 or less.

X mark: The HIC is greater than 350.

The results are shown in the following Table 1.

TABLE 1

| | | | | | | Comp. | Comp. |
|---|---|---|---|---|---|---|---|
| | | Ex. 1 | Ex. 2 | Ex. 3 | Ex. 4 | Ex. 1 | Ex. 2 |
| Constitution | Kind of thermoplastic resin | (1) | (2) | (3) | (4) | (A) | (B) |
| of interlayer | (described in synthesis example) | | | | | | |
| film | Content of thermoplastic resin | 100 | 100 | 100 | 100 | 100 | 100 |
| | (parts by weight) | | | | | | |
| | Kind of plasticizer | 3GO | 3GO | 3GO | 3GO | 3GO | 3GO |
| | Content of plasticizer | 40 | 40 | 40 | 40 | 40 | 40 |
| | (parts by weight) | | | | | | |
| | Thickness (μm) | 760 | 760 | 760 | 760 | 760 | 760 |
| Evaluation | Glass transition temperature | 22 | 23 | 27 | 31 | 27 | 18.3 |
| | (° C.) | | | | | | |
| | Tensile elongation (elongation | 140 | 140 | 140 | 120 | 105 | Breakage |
| | amount at the time of being | | | | | | |
| | applied with 50N load) (mm) | | | | | | |
| | Breaking energy (J) | 4.8 | 5.6 | 10.5 | 20.5 | 12.5 | 2 |
| | HIC (“One circle” represents an | ∘ ∘ | ∘ ∘ | ∘ ∘ | ∘ | x | — |
| | HIC value of 350 or less, and | | | | | | |
| | “Two” circles represent an HIC | | | | | | |
| | value of 200 or less.) | | | | | | |

### EXPLANATION OF SYMBOLS

1: Glass plate-containing laminate (laminated glass)
2: Resin film
2a: First surface
2b: Second surface
11: Glass plate-containing laminate (laminated glass)
12: Resin film
13: First layer (resin film)
14: Second layer (resin film)
15: Third layer (resin film)
13a: Outer surface
15a: Outer surface
21: First laminated glass member (first glass plate)
22: Second laminated glass member

1. A resin film for bonding glass plate members, being used in a state of being bonded to a glass plate, comprising a thermoplastic resin and a plasticizer,
a tensile elongation at 25° C. under a stress load of 50 N being 120 mm or more in a tensile test in accordance with JIS K7113.

2. The resin film for bonding glass plate members according to claim 1, wherein the thermoplastic resin is a polyvinyl acetal resin.

3. The resin film for bonding glass plate members according to claim 1, wherein the plasticizer includes triethylene glycol di-2-ethylhexanoate, and
the content of triethylene glycol di-2-ethylhexanoate is 20 parts by weight or more and 40 parts by weight or less relative to 100 parts by weight of the thermoplastic resin.

4. The resin film for bonding glass plate members according to claim 1, wherein the glass transition temperature is 10° C. or more and 40° C. or less.

5. A glass plate-containing laminate, comprising a first glass plate and the resin film for bonding glass plate members according to claim 1,
the resin film being bonded to the first glass plate.

6. The glass plate-containing laminate according to claim 5, being provided with the first glass plate as a first laminated glass member, the resin film for bonding glass plate members and a second laminated glass member,
the resin film being bonded to the first glass plate,
the resin film being bonded to the second laminated glass member, and
the resin film being arranged between the first glass plate and the second laminated glass member.

7. A method for producing the resin film for bonding glass plate members according to claim 1, the method comprising the steps of:
obtaining a polyvinyl acetal resin as the thermoplastic resin; and
molding a composition prepared by blending the polyvinyl acetal resin and the plasticizer to obtain a resin film for bonding glass plate members,
the step of obtaining the polyvinyl acetal resin including a mixing step of mixing polyvinyl alcohol and an aldehyde and an aging step of aging a resin obtained by the mixing step, and
the aging step including a heating step of heating the resin obtained by the mixing step to an aging temperature and a cooling step of cooling the resin immediately after the heating step.
